(19) United States
(12) Patent Application Publication
(10) Pub. No.: US 2025/0292148 A1
(43) Pub. Date: Sep. 18, 2025

(54) SYSTEMS AND METHODS FOR DETERMINING CONDITION OF AN ENTITY VIA MACHINE LEARNING TECHNIQUE

(71) Applicant: Optum, Inc., Minnetonka, MN (US)

(72) Inventors: S SHIVARAMAN, Bangalore (IN); Mohammad Kashif Ali KHAN, West Sacramento, CA (US)

(21) Appl. No.: 18/604,680

(22) Filed: Mar. 14, 2024

(51) Int. Cl. G06N 20/00; G06Q 10/0639

(52) U.S. Cl. CPC G06N 20/00; G06Q 10/06393

(57) ABSTRACT

Systems and methods are disclosed for analyzing real-time data utilizing machine learning for determining the condition of an entity. The method includes receiving a control dataset and a system dataset or a non-system dataset for a first entity; determining, via input of a first subset of the control dataset into a first machine learning model, classification of the first entity; determining, via input of the system dataset into a second machine learning model or the non-system dataset into a third machine learning model, system score or non-system score, respectively; determining, via input of the system score, the non-system score, or a second subset of the control dataset into a fourth machine learning model, composite score; determining lateral score or longitudinal score based on the classification of the first entity or the composite score; and comparing the lateral score or the longitudinal score with a pre-determined threshold for initiating mitigation action(s).

### TECHNICAL FIELD

This present disclosure relates generally to the field of data processing and predictive analytics. In particular, the present disclosure relates to analyzing real-time data utilizing machine learning for determining a condition of an entity.

### BACKGROUND

Conventional methods for detecting a possible turnover of an entity (or, more generally, a condition of an entity) utilize a limited set of data, and are thus technically challenged in generating an accurate prediction as they fail to comprehensively analyze various relevant datasets associated with the entity. This drawback raises concerns about result accuracy and a high incidence of false positives. Due to the variability of attributable factors across a plurality of entities, it is technically challenging to develop a standardized technique for detecting a condition of a specific entity. Furthermore, the reliance on user-driven approaches (e.g., surveys, self-reporting, etc.) for identifying such conditions introduces potential biases (e.g., an entity may underreport for fear of consequences) that complicate the data analysis process. In addition, integration of various relevant datasets for a comprehensive analysis poses another challenge, as it requires sophisticated algorithms and interdisciplinary collaboration.

### SUMMARY OF THE DISCLOSURE

The present disclosure solves the technical challenges typically encountered during the use of a conventional method, such as those discussed above. Specifically, the present disclosure solved the technical challenges by providing a centralized system that predicts a condition of an entity using machine learning models and generate recommendation(s).

In some embodiments, a computer-implemented method includes: receiving, by one or more processors, data associated with a first entity from a plurality of data sources, wherein the data includes a control dataset and at least one of a system dataset or a non-system dataset; determining, by the one or more processors via input of a first subset of the control dataset into a first machine learning model, a classification of the first entity; determining, by the one or more processors via input of at least one of the system dataset into a second machine learning model or the non-system dataset into a third machine learning model, at least one of a system score for the first entity or a non-system score for the first entity, respectively, each of the system score and the non-system score representing a likelihood of burnout of the first entity; determining, by the one or more processors via input of at least one of the system score, the non-system score, or a second subset of the control dataset into a fourth machine learning model, a composite score for the first entity, the composite score representing a likelihood of turnover of the first entity; determining, by the one or more processors, at least one of a lateral score or a longitudinal score for the first entity based on at least one of the classification of the first entity or the composite score for the first entity; comparing, by the one or more processors, at least one of the lateral score or the longitudinal score with a pre-determined threshold; and initiating, by the one or more processors, performance of one or more mitigation actions based on the comparison.

In some embodiments, a system includes: one or more processors of a computing system; and at least one non-transitory computer readable medium storing instructions which, when executed by the one or more processors, cause the one or more processors to perform operations including: receiving data associated with a first entity from a plurality of data sources, wherein the data includes a control dataset and at least one of a system dataset or a non-system dataset; determining, via input of a first subset of the control dataset into a first machine learning model, a classification of the first entity; determining, via input of at least one of the system dataset into a second machine learning model or the non-system dataset into a third machine learning model, at least one of a system score for the first entity or a non-system score for the first entity, respectively, each of the system score and the non-system score representing a likelihood of burnout of the first entity; determining, via input of at least one of the system score, the non-system score, or a second subset of the control dataset into a fourth machine learning model, a composite score for the first entity, the composite score representing a likelihood of turnover of the first entity; determining at least one of a lateral score or a longitudinal score for the first entity based on at least one of the classification of the first entity or the composite score for the first entity; comparing at least one of the lateral score or the longitudinal score with a pre-determined threshold; and initiating performance of one or more mitigation actions based on the comparison.

In some embodiments, a non-transitory computer readable medium storing instructions which, when executed by one or more processors of a computing system, cause the one or more processors to perform operations including: receiving data associated with a first entity from a plurality of data sources, wherein the data includes a control dataset and at least one of a system dataset or a non-system dataset; determining, via input of a first subset of the control dataset into a first machine learning model, a classification of the first entity; determining, via input of at least one of the system dataset into a second machine learning model or the non-system dataset into a third machine learning model, at least one of a system score for the first entity or a non-system score for the first entity, respectively, each of the system score and the non-system score representing a likelihood of burnout of the first entity; determining, via input of at least one of the system score, the non-system score, or a second subset of the control dataset into a fourth machine learning model, a composite score for the first entity, the composite score representing a likelihood of turnover of the first entity; determining at least one of a lateral score or a longitudinal score for the first entity based on at least one of the classification of the first entity or the composite score for the first entity; comparing at least one of the lateral score or the longitudinal score with a pre-determined threshold; and initiating performance of one or more mitigation actions based on the comparison.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a system for predicting a condition of an entity using machine learning models and generating recommendation(s), according to aspects of the disclosure.

FIG. 2 is a diagram of the components of the machine learning module 117, according to the aspects of the disclosure.

FIG. 3 is a flowchart of a process for predicting a condition of an entity using machine learning models and generate recommendation(s), according to aspects of the disclosure.

FIG. 4A is a diagram showing an example of a process for clustering similar features from a data set to generate behavioral personas of professional entities, according to aspects of the disclosure.

FIG. 4B is a diagram that illustrates the clustering of unlabeled data to generate behavioral personas of professional entities, according to aspects of the disclosure.

FIG. 5A is a diagram showing an example of a process for calculating a lateral score and a longitudinal score for generating recommendation(s), according to aspects of the disclosure.

FIG. 5B is a diagram showing an example of a decision tree depicting a machine learning and/or an artificial intelligence engine determining condition among professional entities, according to aspects of the disclosure

FIG. 6 shows an example machine learning training flow chart.

FIG. 7 illustrates an implementation of a computer system that executes techniques presented herein.

### DETAILED DESCRIPTION OF EMBODIMENTS

This present disclosure relates generally to the field of data processing and predictive analytics. In particular, the present disclosure relates to analyzing real-time data utilizing machine learning for determining a condition of an entity.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the embodiments are not to be considered as limited by the foregoing description.

Various non-limiting embodiments of the present disclosure will now be described to provide an overall understanding of the principles of the structure, function, and use of systems and methods disclosed herein for real-time detection of a condition of an entity and generating recommendations.

Conventional methods struggle to capture the nuanced and context-dependent nature of symptoms associated with entity turnovers, which can manifest differently across a plurality of entities. It is technically challenging to develop methods that account for differences in symptoms among a plurality of entities to determine a condition of a particular entity (e.g., to determine a possible turnover event of an entity). For example, to determine a condition among service provider entities (e.g., healthcare providers), the conventional methods primarily utilize data from surveys or types of data that are collected via user-driven approaches. However, these types of data are often unreliably captured or collected at random times. Accordingly, these conventional methods have several drawbacks, such as: i) adaptation of the user-driven data submission is significantly limited, ii) collected data represents the condition of the entity only at a specific point in time, and iii) mitigation actions are often delayed due to the latency in delivering and processing the collected data. Further, even when a condition is detected based on the collected data, it is difficult to determine the root cause of the condition, whether it be personal, professional, or system-induced.

Furthermore, conventional methods do not comprehensively capture the diverse factors contributing to the condition of the entity and rely solely on a specific set of data. Although the condition of the entity evolves over time, and its symptoms may change in response to varying stressors, the conventional method is static and fails to capture relevant data dynamically due to the difficulty in incorporating time-dependent variables. Thus, the conventional method is limited in its ability to provide real-time detection of the condition of an entity, as well as to provide accurate and reliable predictions.

The present disclosure provides embodiments that address the above shortcomings in the field of data processing and predictive analytics, leading to significant technical improvements in the same field. For instance, system 100 discussed in the present disclosure overcomes the technical shortcomings of the conventional techniques by dynamically collecting and integrating a wide variety of relevant datasets associated with the entity from a plurality of data sources, and comprehensively analyzing the relevant datasets to yield high accuracy and low incidence of false positives in predicting a possible turnover event associated with the entity. Advantageously, the system 100 implements a technique that allows for real-time detection of the condition of a specific entity by taking into consideration the variability of symptoms across a plurality of entities. To that end, the system 100 introduces an exhaustive, effective, and sophisticated process for collecting a wide range of relevant data from various data sources, and organizing and combining a plurality of machine learning models (e.g., supervised and unsupervised machine learning models) configured to generate scores or markers for each entity, where the scores or markers represent various factors that contribute to the condition of the entity.

In one embodiment, the system 100 receives one or more datasets (e.g., a control dataset, a system dataset, a non-system dataset, etc.) associated with an entity from a plurality of data sources. The system 100 determines a classification of the entity by inputting a first subset of the control dataset into a first machine learning model (e.g., an unsupervised machine learning model). The system 100 determines a system score for the entity by inputting the system dataset into a second machine learning model (e.g., a supervised machine learning model), the system score representing a likelihood of burnout of the entity due to professional reasons. The system 100 determines a non-system score for the entity by inputting the non-system dataset into a third machine learning model (e.g., a supervised machine learning model), the non-system score representing a likelihood of burnout of the entity due to personal reasons. The system 100 determines a composite score for the first entity by inputting at least one of the system score, the non-system score, or a second subset of the control dataset into a fourth machine learning model (e.g., a supervised machine learning model), the composite score representing a likelihood of turnover of the entity due to various attributable factors. The system 100 determines at least one of a lateral score or a longitudinal score for the entity based on at least one of the classification or the composite score. The system 100 compares at least one of the lateral score or the longitudinal score with a pre-determined threshold to determine whether to initiate performance of one or more mitigation actions. In such a manner, the system 100 identifies a condition of the entity (e.g., a possible turnover of the entity), which may not be apparent or predictable based on processing a limited set of data.

The above technical improvements, and additional technical improvements, will be described in detail throughout the present disclosure. Also, it should be apparent to a person of ordinary skill in the art that the technical improvements of the embodiments provided by the present disclosure are not limited to those explicitly discussed herein, and that additional technical improvements exist.

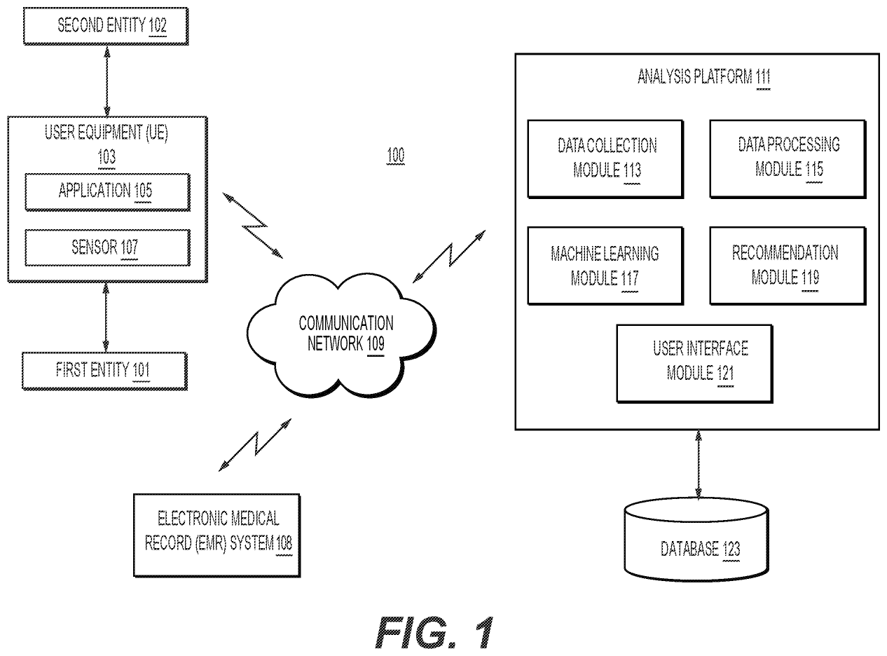

FIG. 1 introduces a capability to implement modern communication and data processing capabilities into methods and systems for predicting a condition of an entity using machine learning models and generating recommendation(s). FIG. 1, an example architecture of one or more example embodiments of the present disclosure, includes the system 100 that comprises a first entity 101, a second entity 102, a user equipment (UE) 103 that includes application(s) 105 and sensor(s) 107, an electronic medical record (EMR) system 108, a communication network 109, an analysis platform 111, and a database 123.

In one instance, the first entity 101 is a professional entity (e.g., primary care physician, specialty physician, general surgeon, specialty surgeon, clinician, medical resident, medical practitioner, nurses, etc.) providing medical-related services to one or more patient(s). In another instance, the first entity 101 includes any professionals in a stressful environment who are likely to experience burnout (e.g., attorneys, engineers, accountants, teachers, drivers, construction workers, social workers, firefighters, managers, and so on) and likely turnover. In one example, the first entity 101 shares health-related information (e.g., stress level, blood pressure level, body temperature, etc.), work-related information (e.g., patient volume, patient complexity, amount of documentation, staffing ratio, etc.), lifestyle data (e.g., eating patterns, drinking patterns, sleeping patterns, exercise patterns, smoking patterns, etc.), and/or personal information (e.g., environmental data, family-related issues, etc.) that assists system 100 in determining burnout and turnover of the first entity 101. In one instance, the health-related information, work-related information, lifestyle data, and personal information are collected through various data collection mechanisms that collect data from a plurality of data sources (e.g., the database 123, the EMR system 108, the UE 103, a regulation database, e.g., state or federal managed databases, and/or any third-party databases). In one instance, the health-related information, work-related information, lifestyle data, and personal information are collected via online surveys.

In one instance, the second entity 102 is a service provider (e.g., medical director, supervisor, or any other decision-making professionals) that interacts with a user interface or a web interface of the UE 103 to assist in an intervention to prevent the first entity 101 from burnout and turnover. For example, the second entity 102 reviews the final turnover flag 547 and determines to intervene through calls, personal visitation, and various other means. In one instance, the intervention includes modifying a work and/or personal schedule, creating or modifying a meditation schedule, recommending time-off, reducing repeatedly done activities that may be detrimental to physical and/or mental health, and so on.

In one instance, the UE 103 includes, but is not restricted to, any type of mobile terminal, wireless terminal, fixed terminal, or portable terminal. Examples of the UE 103, include, but are not restricted to, a mobile handset, a wireless communication device, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), a digital camera/camcorder, an infotainment system, a dashboard computer, a television device, or any combination thereof, including the accessories and peripherals of these devices, or any combination thereof. In addition, the UE 103 facilitates various input means for receiving and generating information, including, but not restricted to, a touch screen capability, a keyboard, and keypad data entry, a voice-based input mechanism, and the like. Any known and future implementations of the UE 103 are also applicable.

In one instance, the application 105 includes various applications such as, but not restricted to, content provisioning applications, software applications, networking applications, multimedia applications, media player applications, camera/imaging applications, storage services, contextual information determination services, location-based services, notification services, social networking services, and the like. In one embodiment, one of the applications 105 at the UE 103 acts as a client for the analysis platform 111 and performs one or more functions associated with the functions of the analysis platform 111 by interacting with the analysis platform 111 over the communication network 109.

By way of example, the sensor 107 includes any type of sensor. In one instance, the sensors 107 include, for example, a network detection sensor for detecting wireless signals or receivers for different short-range communications (e.g., Bluetooth, Wi-Fi, Li-Fi, near field communication (NFC), etc.), a global positioning sensor for gathering location data, a camera/imaging sensor for gathering image data, an audio recorder for gathering audio data, and the like. In another instance, the sensors 107 include, for example, inertial measurement unit (IMU) sensors, electrocardiogram (ECG) sensors, sensors to detect blood glucose level, sensors to measure respiration rate, heart rate detection sensors (e.g., optical Heart Rate (PPG) sensor), sensors to monitor body temperature, micro-electro-mechanical system (MEMS) based miniature motion sensors, gyroscope, accelerometer, magnetometer, infrared sensor, microphone, gas sensor, etc. In one example, the sensors 107 are provided in wearable devices (e.g., watches, internet of things devices, smart clothing, etc.) and/or any health monitoring devices, that capture and analyzes health data (e.g., activity data, vitals data, stress level, heart rate, blood pressure, oxygen saturation level, ECG, etc.), and any other data indicative of health condition of the first entity 101 in real-time.

In one embodiment, the EMR system 108 is an automated system for capturing data (e.g., medical or health data) associated with patient(s) from various databases (e.g., healthcare provider databases, state government databases, federal government databases, public health institutions databases (e.g., Center for Medicare & Medicaid Services (CMS) database), etc.) to generate electronic records for transmission to participating systems (e.g., analysis platform 111). The EMR system 108 transforms a patient's medical chart from a static record into a dynamic, comprehensive record linked to various databases. In one instance, the electronic record includes patient information (e.g., name, address, phone number, date of birth, social security number, etc.), medical information (e.g., diagnosis, test results, prescribed medications, professional services provided, notes entered by the physician or other healthcare personnel, etc.), financial information (e.g., billing information, insurance information, payment information, transaction history, claims data, etc.), and any other relevant information (e.g., transaction reply report (TRR) transactions). In another embodiment, the EMR system 108 collects images of medical records uploaded by the users (e.g., patients, physicians, medical staff, etc.) via application 105 of the UE 103.

In one instance, various elements of the system 100 communicate with each other through the communication network 109. The communication network 109 supports a variety of different communication protocols and communication techniques. In one embodiment, the communication network 109 allows the analysis platform 111 to communicate with the UE 103. The communication network 109 of the system 100 includes one or more networks such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

In one embodiment, the analysis platform 111 is a platform with multiple interconnected components. The analysis platform 111 includes one or more servers, intelligent networking devices, computing devices, components, and corresponding software for predicting or detecting turnover among the first entity 101. In addition, it is noted that the analysis platform 111 may be a separate entity of the system 100.

Burnout among first entities 101 (e.g., physicians, medical professionals, etc.) is particularly hard to identify because it is a state of emotional, physical, and mental exhaustion that is experienced on an individual level and caused by a multitude of different variables. In one example, physicians who reported not having enough time for EHR documentation are more likely to show symptoms of burnout than those who reported having sufficient time. In another example, physicians who spent moderately high or excessive amounts of time on EHR documentation at home are more likely to show burnout symptoms than those who spent minimal or no time on the EHR documentation at home. In another example, physicians who agreed that EHR documentation adds to the frustration of the day are likely to show burnout symptoms than those who disagreed. There is a correlation between certain aspects of provider work and provider burnout leading to turnover.

Turnover of physician (or any other healthcare providers) disrupts patients' care, impacts the culture of healthcare organizations, and puts other physicians under stress. Physician replacement costs (including recruitment, lost revenue, onboarding, and time to return to optimal efficiency) are significant for the healthcare organization, especially given the high rates of burnout and a projected shortfall. Real-time detection of burnout is important to healthcare organizations because it negatively impacts the quality of care, total cost of care, patient satisfaction, physician productivity, and physician retention. In one example, physicians experiencing burnout are more likely to turnover compared to physicians not experiencing burnout. In another example, there is a decrease in patient satisfaction score(s) among patients visiting physicians experiencing burnout compared to physicians not experiencing burnout. In a further example, surgeons experiencing burnout make medical errors compared to surgeons not experiencing burnout. The current methods are technically challenged in detecting, in real-time, burnout among physicians (or any other healthcare providers) which is the leading cause of their turnover.

Conventional approaches utilize surveys to understand turnover among medical professionals through “intent to stay” questions at an individual level and organizational level. However, surveys have several drawbacks, such as: (i) survey adoption is not universal, for example, an organization may receive a survey response rate of about 66% which means the organization is uninformed about the burnout and experience of one-third of their employees; (2) surveys responses are captured at a specific point of time rather than in real-time, hence organizations are only aware of the experience of the employees at the time of the surveys and are uninformed between surveys; (3) actions from surveys are delayed because the survey data is lagging, for example, health professionals experience turnover symptoms from January to March, and are surveyed in March when “intent not to stay” was identified. Survey data collection may have occurred throughout March for analysis in April, and action was taken in May. Even if turnover is detected in a survey, organizations may not understand the root cause of the turnover through the lens of burnout which leads to interventions that are not properly targeted.

The analysis platform 111 identifies, in real-time, first entity 101 (e.g., physicians or any healthcare providers) at risk of departure to help the healthcare delivery organization (e.g., second entity 102) execute an intervention so that they continue their employment. The analysis platform 111 predicts turnover through continuous burnout prediction alongside a plurality of data sources (e.g., EMR, HER, clinical data, claims data, demographics, knowledge-based marketing (KBM), IOT/wearables, modeling techniques, etc.), suggests targeted interventions, and tracks intervention performance. In one embodiment, the analysis platform 111 implements a unique machine learning based turnover risk detection mechanism to generate provider persona, professional burnout score, individual burnout score, and turnover score to proactively identify the first entity 101 intending to turnover. Such fusion of continuous professional burnout score, individual burnout score along with other markers on turnover prediction gives the ability to view a more robust turnover score for each first entity 101, and the ability to measure the provider against their longitudinal and lateral score further makes this method unique and advantageous.

In one embodiment, the analysis platform 111 comprises a data collection module 113, a data processing module 115, a machine learning module 117, a recommendation module 119, a user interface module 121, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one embodiment, the data collection module 113 collects relevant data (e.g., health-related information, work-related information, personal information, lifestyle data, etc.) associated with the first entity 101 through various data collection techniques. In one embodiment, the data collection module 113 uses a web-crawling component to access various databases (e.g., EMR system 108, the database 123, or other information sources (e.g., any third-party databases)), to collect relevant data associated with the first entity 101. In one embodiment, the data collection module 113 includes various software applications (e.g., data mining applications in Extended Meta Language (XML)) that automatically search for and return relevant data regarding the first entity 101. In one example, the data collection module 113 collects health data associated with the first entity 101 via a variety of the UE 103 (e.g., monitoring devices that measures the physiological parameters, such as, stress level, heart rate, blood oxygen saturation levels, respiratory rate, blood pressure, weight, etc.) of the first entity 101. Such monitoring devices include a smartwatch, a smart wristband, a smartphone, smart clothing, or other devices including the sensors 107 (e.g., an ECG sensor, PPG sensor, blood pressure sensors, physiological sensors, any health-related sensors, location sensors, a gyroscope, an accelerometer, a magnetometer, a camera, a microphone, etc.) capable of capturing activity data and vital data of the first entity 101. In one embodiment, these monitoring devices are equipped with operating systems like Android™, iOS™, Windows®, Linux™ OS, or hybrid frameworks that enable efficient integration. In one embodiment, the collection of relevant data is automated (e.g., an automatic human activity recognition technique that captures data from wearable and/or non-wearable monitoring devices). The human activity recognition technique is used to build Human Activity Recognition (HAR) datasets. In one embodiment, the analysis platform 111 provides weightage to health vitals that are relevant to the underlying health conditions of the first entity 101 and compares with industry and individual baseline.

In one embodiment, the data collection module 113 transmits the collected data to the data processing module 115. The data processing module 115 performs data standardization and/or data cleansing on the collected data. In one instance, data standardization includes standardizing and unifying data so that the data are easily processed by other modules. In one instance, the data cleansing includes removing or correcting erroneous data (e.g., redundant, incomplete, or incorrect data) to create high-quality data or validating and correcting values against a known list of entities. The data cleansing technique also includes data enhancement, where data is made more complete by adding related information. The data is then subjected to various data processing methods using machine learning and artificial intelligence algorithms to generate burnout score(s) and turnover score(s).

In one embodiment, the machine learning module 117 is configured for unsupervised machine learning (e.g., the first machine learning model 203) that does not require training using known outcomes 618. The unsupervised machine learning utilizes machine learning algorithms to analyze and cluster unlabeled datasets and discover hidden patterns or data groupings (e.g., similarities and differences within data, without supervision). In one example, the unsupervised machine learning implements approaches that includes clustering (e.g., deep embedded clustering, K-means clustering, hierarchical clustering, probabilistic clustering), association rules, classification, principal component analysis (PCA), or the like. The machine learning module 117 utilizes the unsupervised machine learning techniques to identify behavioral persona of the first entity 101.

In one embodiment, the machine learning module 117 is also configured for supervised machine learning (e.g., the second machine learning model 207, the third machine learning model 221, and/or the fourth machine learning model 235) that utilizes training data (e.g., training data 612 illustrated in the training flow chart 600, for training a machine learning model configured to generate burnout score(s) and turnover score(s) based on the relevant data associated with the first entity 101). In one example, the machine learning module 117 performs model training using training data, e.g., data from other modules, that contains input and correct output, to allow the model to learn over time. The training is performed based on the deviation of a processed result from a documented result when the inputs are fed into the machine learning model, e.g., an algorithm measures its accuracy through the loss function, adjusting until the error has been sufficiently minimized. In one embodiment, the machine learning module 117 randomizes the ordering of the training data, visualizes the training data to identify relevant relationships between different variables, identifies any data imbalances, and splits the training data into two parts where one part is for training a model and the other part is for validating the trained model, de-duplicating, normalizing, correcting errors in the training data, and so on. The machine learning module 117 implements various machine learning techniques, e.g., K-nearest neighbors, cox proportional hazards model, decision tree learning, association rule learning, neural network (e.g., recurrent neural networks, graph convolutional neural networks, deep neural networks), regression, inductive programming logic, support vector machines, Bayesian models, Gradient boosted machines (GBM), LightGBM (LGBM), Xtra tree classifier, etc.

In one embodiment, the machine learning module 117 implements natural language processing (NLP) to analyze, understand, and derive meaning from the texts written by the first entity 101 (e.g., documentation, physician's notes). NLP is applied to analyze text, allowing machines to understand how humans speak/write, enabling real-world applications such as automatic text summarization, sentiment analysis, topic extraction, named entity recognition, parts-of-speech/text tagging, relationship extraction, stemming, and/or the like. In one embodiment, NLP generally encompasses techniques including, but not limited to, keyword search, finding relationships (e.g., synonyms, hypernyms, hyponyms, and meronyms), extracting information (e.g., keywords, key phrases, search terms), classifying, and determining positive/negative sentiment of documents. In one example, the machine learning module 117 utilizes NLP to perform sentiment analysis on a physician's comments and/or feedback in the EMR to determine whether the physician is using strong language and the sentences are getting progressively smaller or whether they are comfortably writing longer sentences that are polite and properly punctuated.

In one embodiment, the machine learning module 117 transmits the turnover score(s) to the recommendation module 119 for further processing. In one instance, the recommendation module 119 determines whether any turnover-mitigating actions should be taken and/or determines which turnover-mitigating actions to take based on the turnover score(s). In one example, the recommendation module 119 determines the turnover score(s) exceeds a preconfigured turnover score threshold level, and generates one or more turnover-mitigating action(s) to prevent the predicted turnover. The one or more turnover-mitigating action(s) include, but is not limited to, modifying a work schedule (e.g., delegating tasks), telemedicine, providing additional staff, providing paid time-off, reducing repeatedly done activities that are detrimental to physical and/or mental health, suggesting exercises, creating a meditation schedule, and so on.

In one embodiment, the recommendation module 119 transmits the turnover-mitigating actions to the user interface module 121. The user interface module 121 enables a presentation of a graphical user interface (GUI) in the UE 103 that facilitates turnover notification and visualization of the turnover-mitigating actions. The user interface module 121 employs various application programming interfaces (APIs) or other function calls corresponding to the application 105 on the UE 103, thus enabling the display of graphics primitives such as icons (e.g., turnover flags), bar graphs, menus, buttons, data entry fields, etc. In another embodiment, the user interface module 121 causes interfacing of guidance information to include, at least in part, one or more annotations, audio messages, video messages, or a combination thereof pertaining to the turnover notification. In one example embodiment, the user interface module 121 operates in connection with augmented reality (AR) processing techniques, wherein various applications, graphic elements, and features interact to present turnover notifications in a format that is understandable by the recipients (e.g., second entity 102).

The above presented modules and components of the analysis platform 111 are implemented in hardware, firmware, software, or a combination thereof. Though depicted as a separate entity in FIG. 1, it is contemplated that the analysis platform 111 is also implemented for direct operation by the respective UE 103. As such, the analysis platform 111 generates direct signal inputs by way of the operating system of the UE 103. In another embodiment, one or more of the modules 113-121 are implemented for operation by the respective UEs, as the analysis platform 111. The various executions presented herein contemplate any and all arrangements and models.

In one embodiment, the database 123 is any type of database, such as relational, hierarchical, object-oriented, and/or the like, wherein data are organized in any suitable manner, including data tables or lookup tables. In one embodiment, the database 123 accesses or includes any suitable data that may be utilized to predict burnout and/or turnover. In one embodiment, the database 123 stores content associated with the first entity 101 and the analysis platform 111, and manages multiple types of information that provide means for aiding in the content provisioning and sharing process. The database 123 includes various information related to the first entity 101 including health-related information (e.g., stress level, blood pressure level, body temperature, etc.), work-related information (e.g., patient volume, patient complexity, amount of documentation, staffing ratio, etc.), lifestyle data (e.g., eating patterns, drinking patterns, sleeping patterns, exercise patterns, smoking patterns, etc.), personal information (e.g., environmental data, family-related information, etc.). It is understood that any other suitable data may be included in the database 123.

In one embodiment, the database 123 includes a machine-learning based training database with a pre-defined mapping defining a relationship between various input parameters and output parameters based on various statistical methods. For example, the training database includes machine-learning algorithms to learn mappings between input parameters related to the first entity 101 (e.g., health-related information, work-related information, lifestyle data, and personal information). In one instance, the training database includes a dataset that includes data collections that are not subject-specific (e.g., data collections based on population-wide observations, local, regional or super-regional observations, burnout-based observations, and the like). Example datasets include demographic data, turnover data, burnout data, patient satisfaction data, scientific and medical-related periodicals and journals, research studies data, nutritional data, exercise data, physician and hospital/clinic location data, and the like. The training database is routinely updated and/or supplemented based on machine learning methods.

By way of example, the UE 103, EMR system 108, the analysis platform 111, and the database 123 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

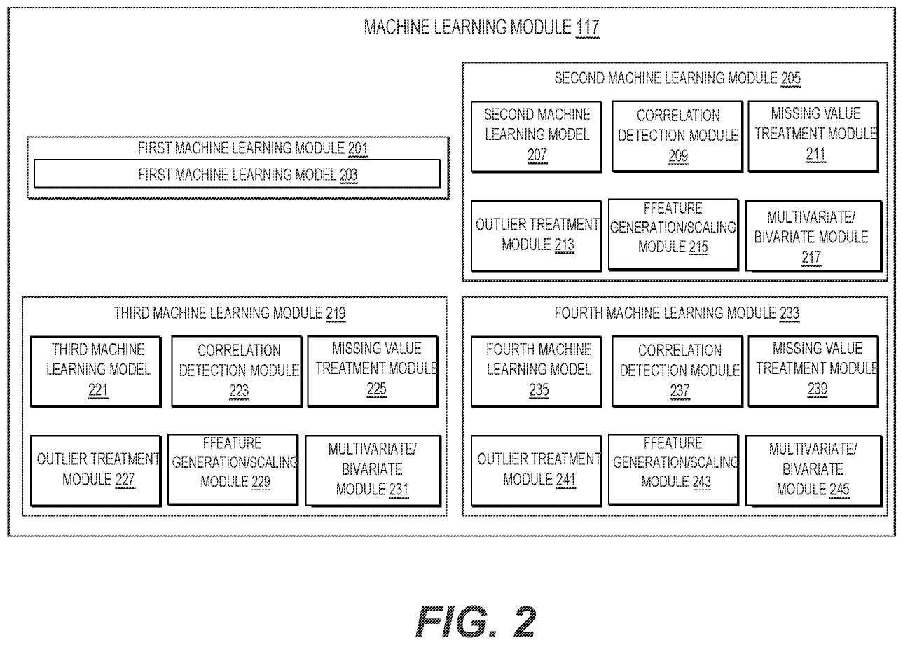

FIG. 2 is a diagram of the components of the machine learning module 117, according to the aspects of the disclosure. In one embodiment, the machine learning module 117 comprises the first machine learning module 201, the second machine learning module 205, the third machine learning module 219, and the fourth machine learning module 233 for predicting turnover.

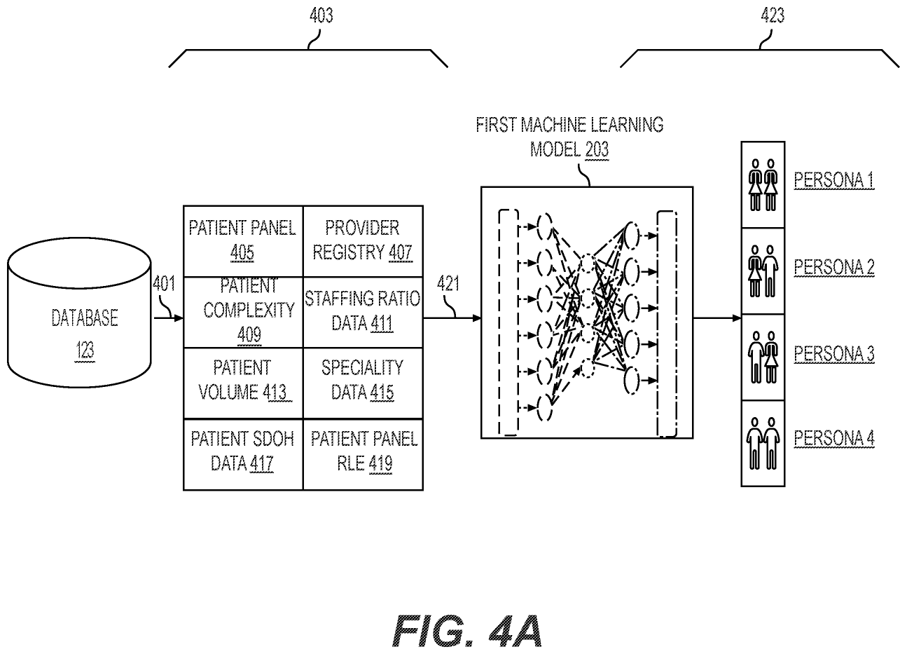

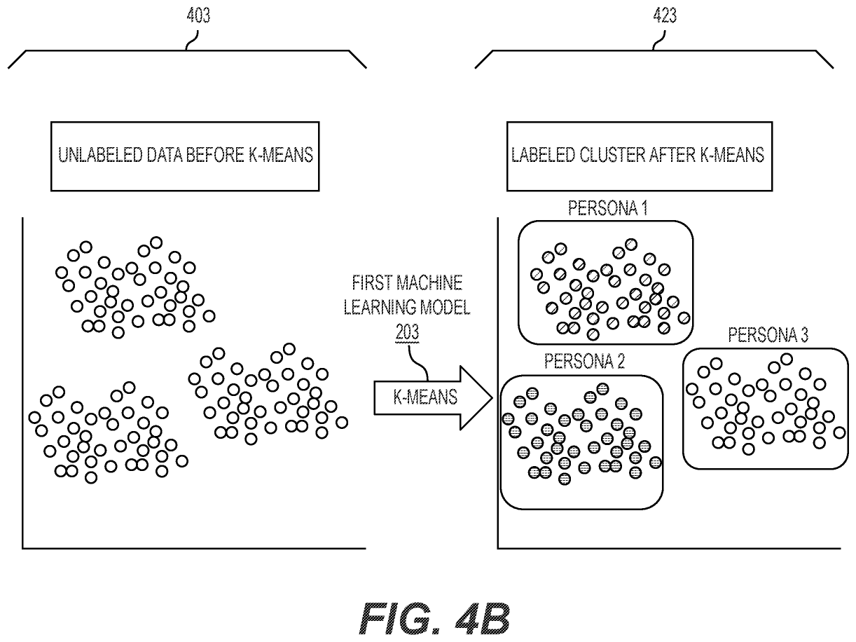

In one embodiment, the first machine learning module 201 includes a first machine learning model 203, which is an unsupervised machine learning model for determining behavioral persona of the first entity 101. The first machine learning model 203 is a clustering model that identifies and groups similar data points, e.g., collecting unlabeled and uncategorized data into groups based on their similarity. In one embodiment, the first machine learning model 203 utilizes various clustering methods, including but not limited to K-means clustering, deep embedded clustering, etc. In one example embodiment, the clustering model selects various clustering features from the database 123, and these features (depicted in FIG. 4A) include:
(i) Patient panel (e.g., a patient panel 405): This data set includes the number of patients and the complexity of patients in the panel of each provider. In this instance, the complexity of patients refers to a complex mixture of patients in the panel of the provider since they do not have the privilege to influence the mixture of patients in their panel. The size and the complexity of the panel are compared to other providers in the same practice to determine whether a particular physician is overburdened.
(ii) Provider registry (e.g., a provider registry 407): This data set includes demographic data (e.g., age information, gender information, location information, income level, education level, household data, ethnic origin, marital status, children data, languages spoken, etc.) and professional information (e.g., name, identifiers, area of expertise, contact information, licensing status, etc.) associated with the first entity 101.
(iii) Patient complexity (e.g., a patient complexity 409): Patient complexity data can be derived from the international classification of diseases, tenth revision (ICD 10) codes in the continuity of care document (CCD) data or collected in the EMR task data (non-obvious choice of data set). This data set includes information on the standard care and decision-making by symptom severity or impairments, diagnostic uncertainty, difficulty engaging care, lack of social safety or participation, disorganization of care, or difficult patient-physician relationships.
(iv) Staffing ratio data (e.g., a staffing ratio data 411): The number of administrative staff has an enormous impact on physicians' workload, for example, if a clinic does not have enough administrative staff the physician ends up performing the administrative work which leads to burnout. This data set includes the number of healthcare staff (e.g., receptionists, nurses, etc.), available per the first entity 101 for performing administrate work.
(v) Patient volume (e.g., a patient volume 413): This data set indicates any variations (e.g., increases or decreases) in the number of patients visiting a specific first entity 101. The patient volume can be used as a signal for monitoring burnout among the first entity 101 (e.g., a sudden increase of patients or conversely a sudden decrease in the number of patients could be a strong signal for burnout). Patient volume variations result from numerous factors, such as, a natural disaster, pandemic, provider leaving the practice, or a competitor opening another facility to provide similar services, etc.
(vi) Specialty data (e.g., a specialty data 415): This data set includes the area of specialty of the first entity 101. Burnout does not impact all specialties uniformly, for example, neurologists and primary care physicians have the highest burnout rates while plastic reconstruction surgeons have the lowest level of burnout.
(vii) Patient social determinants of health (SDOH) data (e.g., a patient SDOH data 417): This data set indicates non-medical factors that influence health outcomes of the patients. For example, SDOH data includes (i) the conditions in which the patients are born, grow, and live (e.g., housing, transportation, neighborhood safety, access to clean air and water, etc.), (ii) racism, discrimination, and violence (e.g., education, job opportunities, income, etc.), (iii) nutrition and health (e.g., access to nutritious food after the appointment(s) or surgery, access to gym/recreational facilities, etc.). While physicians are encouraged to gather SDOH data from patients, most are unable due to time constraints and the inability to offer assistance to the patient due to a lack of resources. Their inability to help patients facing food insecurity, domestic violence, or incapability of affording medication takes a toll on their ability to make an impact on the community or the patient.
(viii) Race, language, and ethnicity (RLE) of the patient (e.g., a patient panel RLE 419): This data set provides information on the race, language, and ethnicity of the patients. For example, the first entity 101 are negatively impacted if they cannot speak the language of their patients. Since patients cannot understand their physicians, the quality-of-care drops leading to personalized exertion, and the physicians are penalized for poor outcomes by the Centers for Medicare & Medicaid (CMS) services. For example, the race and gender of the patients also play an integral role because some patients do not want to discuss certain issues with the opposite gender.
(ix) Other data sets: The data sets include various types of information pertaining to the first entity 101 (e.g., paid-time-off (PTO) usage, revenue models used, heart rate data, voice recognition analytics, claims data, financial investment data, financial outlook data, social media usage data, past training completed, engagement within the organization, intervention adherence, etc.). The data sets also include EMR task data comprising task data fields with time stamps for task generation, completion, and other data values. The number of delayed tasks has a high correlation with first entity 101's burnout leading to turnover. The data sets also include EMR time of use (e.g., time spent at home charting to document is considered a part of the professional burnout score). The data sets also include EMR time spent data indicating the time spent by the first entity 101 performing administrative tasks (e.g., documentation). The duration of administrative work is considered while calculating the burnout score leading to turnover. The data sets also include net promoter score (NPS), an index that measures patient experience score and their willingness to recommend the physicians.

In one embodiment, the second machine learning module 205 includes a second machine learning model 207, which is a supervised machine learning model for determining a professional burnout score for the first entity 101 based on professional data associated with the first entity 101. The professional burnout score is determined using a suitable supervised machine learning technique such as, GBM, LGBM, Xtra tree classifier, and the like. The second machine learning model 207 is supported by a correlation detection module 209, a missing value treatment module 211, an outlier treatment module 213, a feature generation/scaling module 215, and a multivariate/bivariate module 217 during the pre-processing and feature engineering stages, to form a master data set that gets fed into the second machine learning model 207.

In one embodiment, the correlation detection module 209 processes the data received from the data processing module 115 for a statistical measure of the relationship between two or more variables. In one embodiment, the correlation detection module 209 determines a degree of relationship between two or more variables based upon changes in one variable in relation to the other variables. If two variables are closely correlated, then one variable can be predicted from the other, e.g., the correlation detection module 209 determines seven attributes are correlated and provides the same information, hence instead of using all seven attributes, any one of these attributes may be utilized. In one example embodiment, two variables are positively correlated when the value of one variable increases with an increase in the value of the other variable(s). In another example embodiment, two variables are negatively correlated when the value of one variable increases with a decrease in the value of the other variable(s).

The problem of missing values is common in datasets and these values can bias the results of the machine learning models and reduce the accuracy of the model. In one embodiment, the missing value treatment module 211 identifies the missing values in datasets (e.g., missing completely at random (MCAR), missing at random (MAR), missing not at random (MNAR)), and ascertains the reasons for the missing data (e.g., corrupted past data, failure in recording data due to human error, etc.). The missing value treatment module 211 develops a strategy to handle the missing values (e.g., imputing missing values for a continuous variable, imputing missing values for a categorical variable, using algorithms that support missing values, prediction of missing values, imputation using deep learning library, or any other imputation methods). In one example embodiment, the missing value treatment module 211 identifies the missing value of the attribute in the dataset varies from 5% to 50%. The missing value treatment module 211 determines whether to input the dataset having up to 50% missing values to the machine learning models.

The performance of any machine learning model depends on the data it is trained on, and it can be influenced by changing the distribution or adding outliers in the input data. Outliers can lead machine learning models to less accuracy and larger training time, hence the outlier treatment module 213 handles the outliers before providing the data for training. Outliers are different values, e.g., abnormally low or abnormally high, and their presence often skews the results of statistical analyses on the dataset. In one example embodiment, the outliers include global outliers (e.g., a data point whose value is far outside the entirety of the dataset), contextual outliers (e.g., an individual data instance is anomalous in a specific context), or collective outliers (e.g., a collection of data points is anomalous concerning the entire data set). In one embodiment, the outlier treatment module 213 utilizes various calculations (e.g., standard deviation, percentile, etc.) or various algorithms (e.g., elliptic envelope algorithm, isolation forest algorithm, one-class support vector machines algorithm, local outlier factor (LOF) algorithm, etc.) to identify outliers in a dataset. In one example embodiment, a dataset comprises one physician with 50 panels, sixty physicians with 100 panels, and one physician with 300 panels. The outlier treatment module 213 identifies 50 and 300 panels as outliers, and replaces them with an average value that works best for statistical distribution so that it is easier for the model to learn and provide better information.

The quality of a feature in a dataset has immense effect on model performance. In fact, not all features are relevant, and too many features adversely affect the model performance, e.g., as the number of features increases, it becomes difficult for the model to learn mappings between features and target. In one embodiment, the feature generation/scaling module 215 constructs new features from the existing features in a dataset to better relate to the target. In one embodiment, the feature generation/scaling module 215 selects a set of relevant attributes from large datasets, thereby making it computationally feasible to use certain machine learning and data analytic algorithms. Such selection of relevant data improves the quality and accuracy of the result. In one example embodiment, the feature generation/scaling module 215 combines existing features (e.g., a patient panel and service cost) from a dataset to create a new feature (e.g., the total cost of care). In another embodiment, feature generation/scaling module 215 utilizes scaling techniques for adjusting the values in the same range or same scale ensuring one variable is not dominated by the other, thereby creating an accurate machine learning algorithm.

In one embodiment, the multivariate/bivariate module 217 evaluates two variables to determine relationships between them. In another embodiment, the multivariate/bivariate module 217 evaluates multiple variables (more than two) to identify any possible association between them. The multivariate/bivariate module 217 predicts future risks (e.g., burnout, turnover, etc.) and assists in data driven decision making.

In one embodiment, the third machine learning module 219 includes a third machine learning model 221, which is a supervised machine learning model for determining an individual burnout score for the first entity 101 based on personal data associated with the first entity 101. The personal burnout score is determined using a suitable supervised machine learning technique such as, GBM, LGBM, Xtra tree classifier, and the like. The third machine learning model 221 is supported by a correlation detection module 223, a missing value treatment module 225, an outlier treatment module 227, a feature generation/scaling module 229, and a multivariate/bivariate module 231 during the pre-processing and feature engineering stages, to form a master data set that gets fed into the third machine learning model 221. The functionalities of the correlation detection module 223, the missing value treatment module 225, the outlier treatment module 227, the feature generation/scaling module 229, and the multivariate/bivariate module 231 are similar to those of the correlation detection module 209, the missing value treatment module 211, the outlier treatment module 213, the feature generation/scaling module 215, and the multivariate/bivariate module 217 discussed above.

In one embodiment, the fourth machine learning module 233 includes a fourth machine learning model 235, which is a supervised machine learning model for determining a turnover score for the first entity 101 based on the professional burnout score and the individual burnout score. The turnover score is determined using a suitable supervised machine learning technique such as, GBM, LGBM, Xtra tree classifier, and the like. The fourth machine learning model 235 is supported by a correlation detection module 237, a missing value treatment module 239, an outlier treatment module 241, a feature generation/scaling module 243, and a multivariate/bivariate module 245 during the pre-processing and feature engineering stages, to form a master data set that gets fed into the fourth machine learning model 235. The functionalities of the correlation detection module 237, the missing value treatment module 239, the outlier treatment module 241, the feature generation/scaling module 243, and the multivariate/bivariate module 245 are similar to those of the correlation detection module 209, the missing value treatment module 211, the outlier treatment module 213, the feature generation/scaling module 215, and the multivariate/bivariate module 217 discussed above.

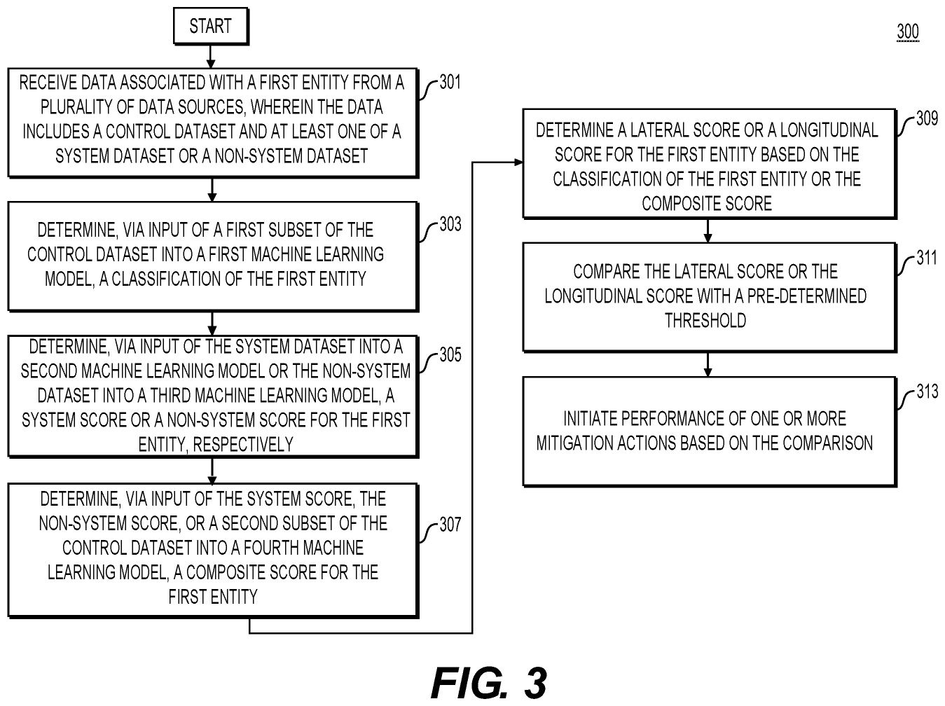

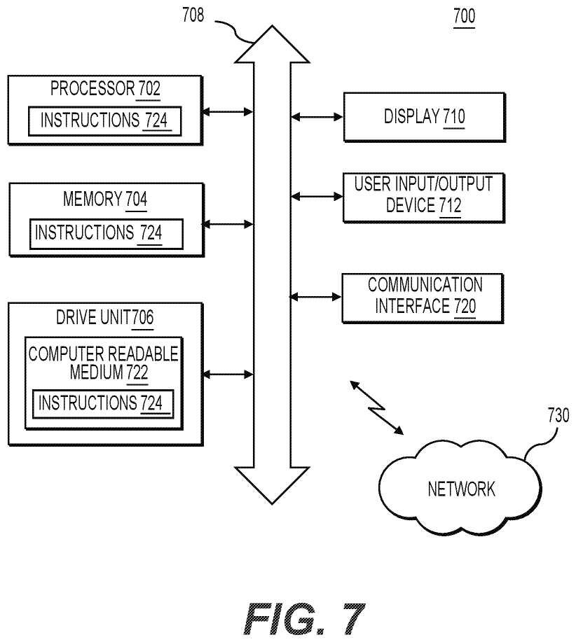

FIG. 3 is a flowchart of a process for predicting a condition of an entity using machine learning models and generate recommendation(s), according to aspects of the disclosure. In various embodiments, the analysis platform 111 and/or any of the modules 113-121 performs one or more portions of the process 300 and are implemented using, for instance, a chip set including a processor and a memory as shown in FIG. 7. As such, the analysis platform 111 and/or any of modules 113-121 provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 are performed in any order or combination and need not include all of the illustrated steps.

In step 301, the analysis platform 111 receives data associated with a first entity (e.g., first entity 101) from a plurality of data sources (e.g., EMR system 108, database 123, etc.). The data includes a control dataset (e.g., clustering feature 403 of FIG. 4A) and at least one of a system dataset (e.g., professional data in the storage 509) or a non-system dataset (e.g., personal data in storage 525). In one embodiment, the control dataset includes patient panel data, provider registry data, patient complexity data, staffing ratio data, specialty data, patient volume data, patient social determinants of health (SDOH) data, or patient panel race, language, and ethnicity (RLE) data. In one embodiment, the system dataset includes electronic health record (EHR) data, clinical data, national provider identifier (NPI) data, intervention adherence data, net prompter score (NPS) data, historical training data, or task data. In one embodiment, the non-system dataset includes environmental data, social determinants of health (SDOH) data, financial data, health condition data, or activity data.

In step 303, the analysis platform 111 determines, via input of a first subset of the control dataset into a first machine learning model (e.g., the first machine learning model 203), a classification of the first entity. In one embodiment, determining the classification of the first entity includes the analysis platform 111 scaling the first subset of the control dataset associated with the first entity to provide an equal weight to each variable of the first subset of the control dataset. The analysis platform 111 inputs the scaled first subset of the control dataset into the first machine learning model configured to determine the classification of the first entity (e.g., behavioral persona 423 of FIG. 4A). In one instance, the first machine learning model includes a deep embedded clustering algorithm or a K-means clustering algorithm.

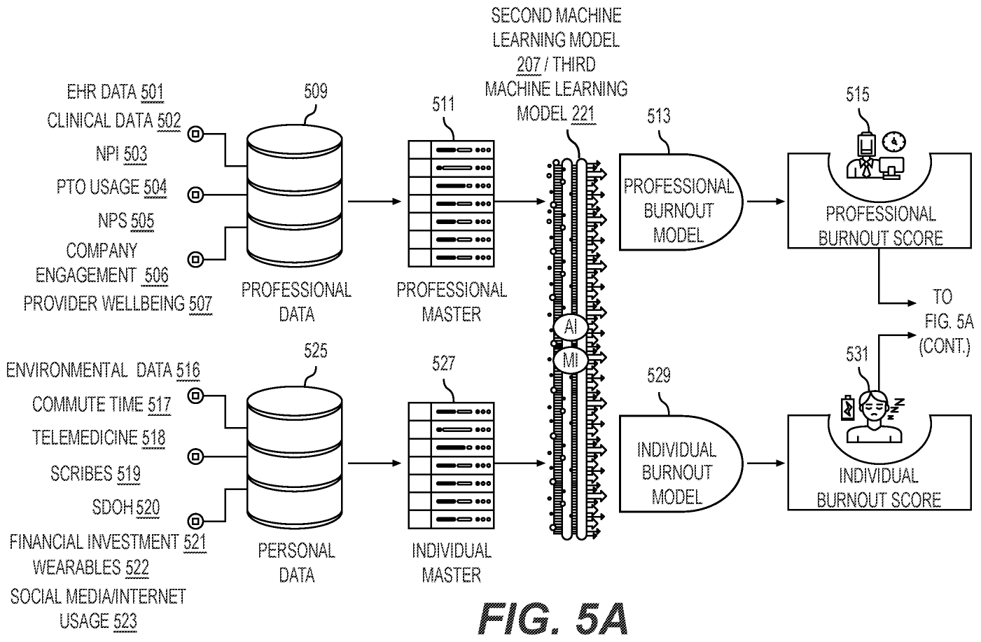

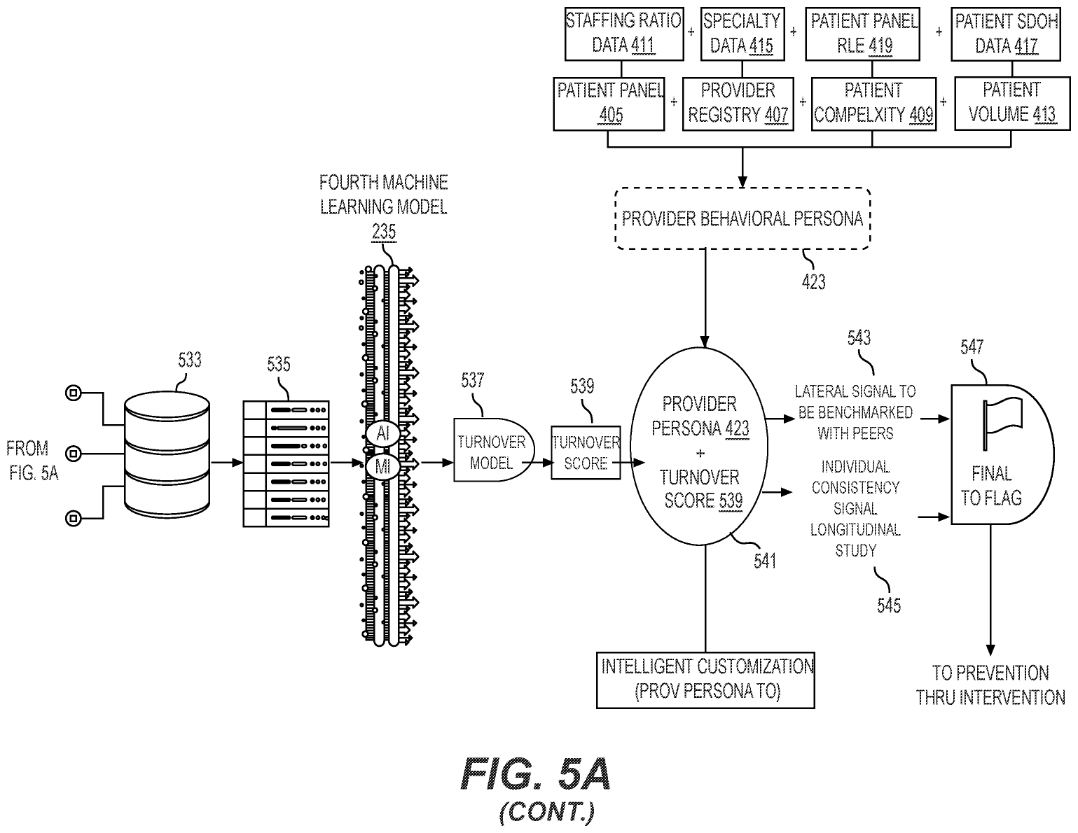

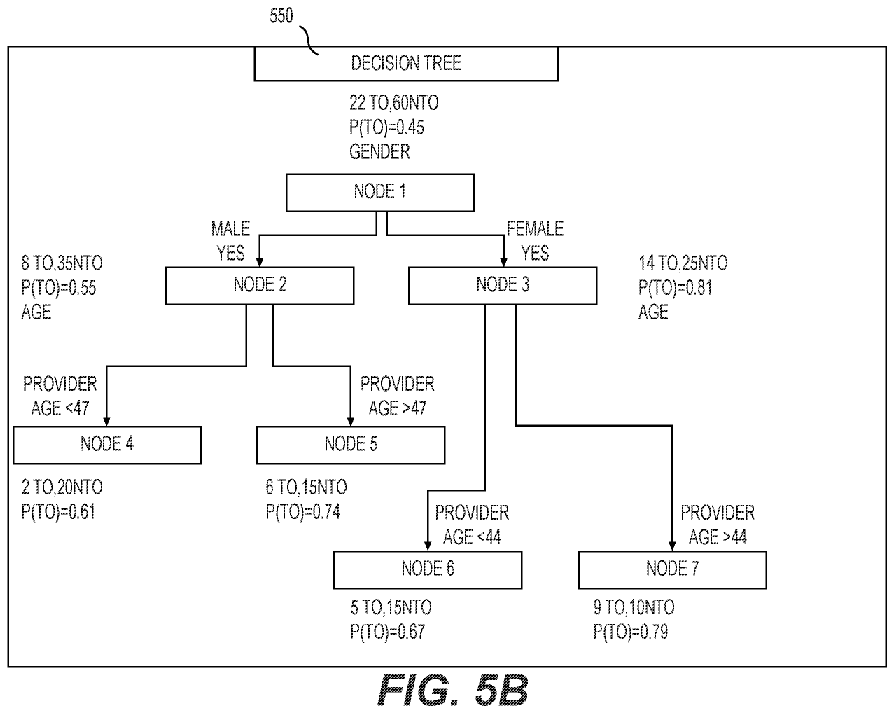

In step 305, the analysis platform 111 determines, via input of the system dataset into a second machine learning model (e.g., second machine learning model 207) and/or the non-system dataset into a third machine learning model (e.g., third machine learning model 221), a system score (e.g., professional burnout scores 515 of FIG. 5A) and/or a non-system score (e.g., individual burnout scores 531 of FIG. 5A) for the first entity 101, respectively. The system score and the non-system score represent a likelihood of burnout of the first entity. In one embodiment, the analysis platform 111 updates the system score or the non-system score in real-time, near real-time, or on a scheduled basis to dynamically determine the likelihood of burnout of the first entity.

In one embodiment, the analysis platform 111 trains the second machine learning model by pre-processing a training system dataset to generate a first master training dataset. The pre-processing includes correlation detection, missing value treatment, outlier treatment, new features creation, scaling, or multivariate analysis. The analysis platform 111 splits the first master training dataset into a first training dataset and a first validation dataset. The analysis platform 111 inputs the first training dataset into the second machine learning model to determine a training system score. One or more performance parameters of the second machine learning model are measured using the first validation dataset.

In one embodiment, the analysis platform 111 trains the third machine learning model by pre-processing a training non-system dataset to generate a second master training dataset. The pre-processing includes correlation detection, missing value treatment, outlier treatment, new features creation, scaling, or multivariate analysis. The analysis platform 111 splits the second master training dataset into a second training dataset and a second validation dataset. The analysis platform 111 inputs the second training dataset into the third machine learning model to determine a training non-system score. One or more performance parameters of the third machine learning model are measured using the second validation dataset.

In step 307, the analysis platform 111 determines, via input of at least one of the system score, the non-system score, or a second subset of the control dataset into a fourth machine learning model (e.g., fourth machine learning model 235), a composite score (e.g., turnover score 539) for the first entity. The composite score represents the likelihood of turnover of the first entity. In one embodiment, the analysis platform 111 trains the fourth machine learning model by pre-processing a training system score, a training non-system score, or a subset of a training control dataset to generate a third master training dataset. The pre-processing includes correlation detection, missing value treatment, outlier treatment, new feature creation, scaling, or multivariate analysis. The analysis platform 111 splits the third master training dataset into a third training dataset and a third validation dataset. The analysis platform 111 inputs the third training dataset into the fourth machine learning model to determine a training composite score. One or more performance parameters of the fourth machine learning model are measured using the third validation dataset. In one embodiment, the first, the second, or the third machine learning model is at least one of Gradient Boosting Machine (GBM), LightGBM (LGBM), or Extra Trees Classifier.

In step 309, the analysis platform 111 determines a lateral score (e.g., lateral turnover risk score 543 of FIG. 5A) and/or a longitudinal score (e.g., longitudinal turnover risk score 545 of FIG. 5A) for the first entity based on the classification of the first entity or the composite score for the first entity. In one embodiment, the lateral score includes a comparison between one or more scores associated with the first entity and one or more scores associated with other entities (e.g., colleagues, or any other professionals in a similar field, etc.) within a pre-determined time threshold. In one embodiment, the longitudinal score includes a comparison between multiple scores associated with the first entity within a pre-determined time threshold.

In step 311, the analysis platform 111 compares the lateral score and/or the longitudinal score with a pre-determined threshold (e.g., pre-determined turnover threshold limit). In one embodiment, the lateral and longitudinal turnover risk scores are combined or averaged before being compared to the pre-determined threshold.

In step 313, the analysis platform 111 initiates the performance of one or more mitigation actions based on the comparison. In one embodiment, the analysis platform 111 determines one or more mitigation actions upon determining the lateral score or the longitudinal score exceeds the pre-determined threshold. One or more mitigation actions include an intervention by a second entity for managing the workload of the first entity, modifying the work schedules of the first entity, delegating activities determined as detrimental to the mental health of the first entity, or recommending a time-off or stress-relieving activities. In one embodiment, the analysis platform 111 analyzes the lateral score or the longitudinal score to measure efficacy of the one or more mitigation actions or adherence to one or more mitigation actions.

FIG. 4A is a diagram showing an example of a process for clustering similar features from a data set to generate behavioral personas of professional entities, according to aspects of the disclosure. In step 401, the analysis platform 111 retrieves clustering features 403 (e.g., the patient panel 405, the provider registry 407, the patient complexity 409, the staffing ratio data 411, the patient volume 413, the specialty data 415, the patient SDOH data 417, and the patient panel RLE 419) from the database 123. The analysis platform 111 scales the clustering features 403 by utilizing standard scaling methods to give equal weightage to the clustering features 403 to bring them on the same scale. For example, the clustering features 403 may not be on the same scale, for instance, the patient panel 405 is measured in the thousands whereas patient complexity is measured in a level of 1-5, hence the analysis platform 111 brings the clustering features 403 with varying measurements under one scale for unsupervised or supervised learning.

In step 421, the analysis platform 111 inputs the scaled clustering features 403 into the first machine learning model 203. As previously discussed in FIG. 2, the first machine learning model 203 utilizes machine learning techniques or statistical unsupervised modeling techniques (e.g., K-means, deep embedded clustering, etc.) to generate the behavioral persona 423 for the first entity 101 by grouping the uncategorized clustering features 403. For example, persona 1 of the behavioral persona 423 indicates that the first entity 101 has a low patient panel with a good staffing ratio but sees mostly high-risk patients. For example, persona 2 of the behavioral persona 423 indicates that the first entity 101 has a high patient panel with a low staffing ratio but sees mostly medium to low-risk patients. For example, persona 3 of the behavioral persona 423 indicates that the first entity 101 has a medium patient panel but sees only low-risk patients. For example, persona 4 of the behavioral persona 423 indicates that the first entity 101 has a low patient panel with a medium staffing ratio but sees mostly low-risk patients. The behavioral persona 423 does not produce a score, since there is no score for clustering. If the data points are homogenous, then a cluster is created, and clusters should be heterogeneous across the group, e.g., cluster 1 should be different from cluster 2.

FIG. 4B is a diagram that illustrates the clustering of unlabeled data to generate behavioral personas of professional entities, according to aspects of the disclosure. In one instance, the clustering features 403 represents unlabeled data (e.g., data that have not been tagged with labels identifying characteristics, properties, or classifications). The analysis platform 111 inputs the unlabeled clustering features 403 into the first machine learning model 203. In this embodiment, the first machine learning model 203 utilizes the K-means unsupervised modeling technique to label and categorize the unlabeled clustering features 403 into the behavioral personas 423. It should be understood that any other unsupervised or supervised modeling techniques may be implemented by the first machine learning model 203 to label and categorize the unlabeled clustering features 403.

In one embodiment, the analysis platform 111 determines the optimal number of clusters in a data set by utilizing various cluster analysis methods (e.g., the Elbow method in which the sum of squares at each number of clusters is calculated and graphed, and a change of slope from steep to shallow (an elbow) is identified to determine the optimal number of clusters).

FIG. 5A is a diagram showing an example of a process for calculating a lateral score (e.g., lateral turnover risk score 543) and a longitudinal score (e.g., longitudinal turnover risk score 545) for generating recommendation(s), according to aspects of the disclosure. As discussed, burnout can occur due to individual attributes and/or professional attributes. For example, the first entity 101 (e.g., physician, medical professional, etc.) is stressed because of personal reasons (e.g., lengthy commute time to work, the vicinity he/she is staying, family responsibilities, etc.) and professional reasons (e.g., heavy workload, responsible for high-risk patients, substantial administrative work, etc.). The analysis platform 111 differentiates professional burnout attributes from individual burnout attributes to generate individual and professional burnout models for determining the reasons for burnout for the first entity 101 as an individual and as a professional.

In one embodiment, the analysis platform 111 collects professional data associated with the first entity 101 (e.g., EHR data 501, clinical data 502, national provider identifier (NPI) data 503, PTO usage 504, NPS 505, company engagement 506, provider wellbeing 507, etc.) from various data sources (e.g., the database 123), and stores the professional data in storage 509. The professional data in the storage 509 goes through a data pre-processing pipeline (e.g., data cleaning, data integration, data reduction, data transformation, etc.) to form a professional master data set 511. During a training phase, the analysis platform 111 splits the professional master data set 511 into a training data set and a validating data set. The analysis platform 111 then inputs the training data set into the second machine learning model 207 and the validation data set measures the performance (e.g., recall, precision, accuracy, area under the curve (AUC), etc.) of the second machine learning model 207. During a production phase, the analysis platform 111 generates the professional master data set associated with a specific entity and the master data set is input into the second machine learning model 207 for generating a professional burnout score 515 for the entity. In this embodiment, the second machine learning model 207 is a supervised machine learning model that utilizes one or more supervised learning algorithms (e.g., GBM, LGBM, Xtra tree classifier, etc.) to build a professional burnout model 513 that predicts/determines professional burnout scores 515 for each professional attributes of the first entity 101. In one embodiment, the professional burnout model 513 generates a probability and the probability is converted into the professional burnout scores 515.

In one embodiment, the analysis platform 111 collects personal data associated with the first entity 101 (e.g., environmental data 516, commute time 517, telemedicine 518, scribes 519, SDOH 520, financial investments 521, wearables 522, social media/internet usage 523, etc.) from various data sources (e.g., the database 123), and stores the personal data in storage 525. The personal data in storage 525 goes through a data pre-processing pipeline (e.g., data cleaning, data integration, data reduction, data transformation, etc.) to form an individual master data set 527. During a training phase, the analysis platform 111 splits the individual master data set 527 into a training data set and a validating data set. The analysis platform 111 then inputs the training data set into the third machine learning model 221 and the validation data set measures the performance (e.g., recall, precision, accuracy, area under the curve (AUC), etc.) of the third machine learning model 221. During a production phase, the analysis platform 111 generates the individual master data set associated with a specific entity and the master data set is input into the third machine learning model 221 for generating an individual burnout score 531 for the entity. In this embodiment, the third machine learning model 221 is a supervised machine learning model that utilizes one or more supervised learning algorithms to build an individual burnout model 529 that predicts/determines individual burnout scores 531 for each personal attributes of the first entity 101. For example, the individual burnout model 529 generates a probability, and the probability is converted into individual burnout scores 531. In one instance, the analysis platform 111 utilizes experience surveys to generate the individual burnout scores 531. For example, the first entity 101 is provided an experience survey that includes questions regarding the severity of the burnout experienced by the first entity 101. A Mini Z burnout survey may be utilized, but this survey can be replaced by any other physician engagement survey.

In one embodiment, the analysis platform 111 stores the predicted professional burnout scores 515 and the individual burnout scores 531 in storage 533, and the stored scores are utilized to form a master data set 535. During a training phase, the analysis platform 111 splits the master data set 535 into a training data set and a validating data set. The analysis platform 111 then inputs the training data set into the fourth machine learning model 235 and the validation data set measures the performance (e.g., recall, precision, accuracy, area under the curve (AUC), etc.) of the fourth machine learning model 235. During a production phase, the analysis platform 111 generates a master data set associated with a specific entity and the master data set is input into the fourth machine learning model 235 for generating a turnover score 539 for the entity. In this embodiment, the fourth machine learning model 235 is a supervised machine learning model that utilizes one or more supervised learning algorithms to build a turnover model 537 that predicts/determines turnover scores 539 for the first entity 101. For example, the turnover model 537 generates a probability, and the probability is converted into turnover scores 539. In such manner, the analysis platform 111 via the machine learning module 117 utilizes multiple data sets and scores as the source of truth for determining which providers are experiencing burnout and are likely to turnover, and is also used for validating the performance of the machine learning models (e.g., the second machine learning model 207, the third machine learning model 221, and the fourth machine learning model 235). In one instance, these data sets pre-exist but have not been combined and utilized by the machine learning module 117. For example, the data sets include provider behavioral personas 423 (from FIG. 4A), professional burnout scores 515, and individual burnout scores 531.

In one embodiment, the analysis platform 111 performs intelligent customization 541 on the turnover score 539 and the provider behavioral personas 423 by scoring each identified persona to generate a provider persona turnover score. The provider persona turnover score is then leveraged to generate the lateral turnover risk score 543 (to be benchmarked with peers) and the longitudinal turnover risk score 545 (individual consistency signal). In one example, a lateral turnover risk score 543 refers to comparing the turnover risk score with other professional entities on a certain time frame (e.g., real-time, near real-time, daily, bi-weekly, monthly, pre-scheduled basis, etc.), whereas a longitudinal turnover risk score refers to comparing the turnover risk scores of the same professional entity on a certain time frame (e.g., real-time, near real-time, for the last 12 rolling months, pre-scheduled basis, etc.) for individual tracking. The lateral turnover risk score 543 and the longitudinal turnover risk score 545 are used in tandem or as a comparison measure against which the first entity 101 is benchmarked for improving the quality of care, total cost of care, patient satisfaction, and provider productivity.

In one embodiment, the analysis platform 111 compares the lateral turnover risk score 543 and the longitudinal turnover risk score 545 with a pre-determined turnover threshold limit. In one embodiment, the lateral and longitudinal turnover risk scores are simply combined for comparison with the predetermined turnover threshold limit. In another embodiment, the lateral and longitudinal turnover risk scores are averaged before being compared to the pre-determined turnover threshold limit. For example, the lateral turnover risk score 543 is compared with overall lateral turnover scores (e.g., by taking the average of all professional scores) of a care delivery organization (CDO) or a group on a pre-scheduled basis (e.g., month-to-month). For example, a longitudinal average of the CDO or group is compared with the longitudinal turnover risk score 545 on a pre-scheduled basis (e.g., the last 12 rolling months). The overall lateral turnover scores may vary from the longitudinal average.

In one embodiment, the analysis platform 111 via the user interface module 121 triggers a final turnover flag 547 in a user interface of the UE 103 upon determining the lateral turnover risk score 543 and the longitudinal turnover risk score 545 exceeds the pre-determined turnover threshold limit for a set period indicating the first entity 101 is steering towards turnover. The final turnover flag 547 is utilized for generating recommendations. In one instance, the recommendations include intervention by the service providers (e.g., medical directors, supervisors, or any other professionals assisting in the intervention) through calls, personal visitation, and so on. In one instance, the recommendations include modifying a work and/or personal schedule of the first entity 101, creating or modifying a meditation schedule for the first entity 101, recommending time-off, and reducing repeatedly done activities that may be detrimental to the user's physical and/or mental health.

In another embodiment, the analysis platform 111 generates a report that summarizes one or more reasons the first entity 101 is experiencing burnout and likely to turnover, and an action plan to prevent the turnover from occurring. For example, physicians who are likely to turnover due to longer commute times are given dedicated telemedicine time and the ability to work from home to prevent them from experiencing burnout caused by the long commute. For example, physicians who are likely to turnover due to heavy documentation are provided with tools that automate notetaking or scribes that provide transcription services to reduce burnout caused by documentation. For example, clinics or organizations are recommended to provide their clinicians with the ability to communicate with the leadership and engage the clinicians in improving clinical and non-clinical processes at the clinic to lower turnover rates.

As previously discussed, turnover is represented by a probability output of the machine learning module 117, which is interpreted as a likelihood for the first entity 101 to turnover based on professional and/or individual attributes. In one instance, the professional and/or individual attributes are relooked and/or refreshed on a scheduled basis to capture the most recent data pertaining to the first entity 101. In one instance, the analysis platform 111 captures and analyzes the lateral turnover risk score 543 and the longitudinal turnover risk score 545 for measuring intervention efficacy and the first entity 101's adherence to the recommendation(s) for reducing turnover, extending better care, and improving quality and overall provider and patient experience. As discussed, the first entity 101 experiencing healthier environments has a lower propensity to turnover. If the first entity 101 is predicted to turnover, the analysis platform 111 intervenes early and processes the signal that activated the final turnover flag 547. For example, the volume of the patient and amount of documentation triggered the final turnover flag 547, whereupon the analysis platform 111 focuses on these two attributes for a targeted solution. In such a manner, the analysis platform 111 provides a good work-life balance among working professionals, and can be leveraged as a recruitment and retention tool. Additionally, based on the issues that are triggering the final turnover flag 547, the analysis platform 111 generates recommendations to combat the issues and track their efficacy.

FIG. 5B is a diagram showing an example of a decision tree depicting a machine learning and/or an artificial intelligence engine determining condition (e.g., turnover) among professional entities, according to aspects of the disclosure. In this example embodiment, a decision tree 550 initiates with 22 physicians experiencing turnover (TO), 60 physicians experiencing non turnover (NTO), and a TO probability of 0.45. In node 1, the decision tree 550 selects gender (male/female) as the next best attribute, whereupon two nodes are created (e.g., node 2 for male physicians and node 3 for female physicians). In node 2, the decision tree 550 determines 8 male physicians are experiencing TO, 35 male physicians are experiencing NTO, and a TO probability is 0.55. In node 3, the decision tree 550 determines 14 female physicians are experiencing TO, 25 female physicians are experiencing NTO, and a TO probability is 0.81.

The decision tree 550 at nodes 2 and 3 selects age as the next best attribute, whereupon four nodes are created (e.g., nodes 4 and 5 from node 2, and nodes 6 and 7 from node 3). Node 4 indicates that amongst the male physicians below the age of 47, 2 are experiencing TO, 20 are experiencing NTO, and a TO probability is 0.61. Node 5 indicates that between the male physicians above the age of 47, 6 are experiencing TO, 15 are experiencing NTO, and a TO probability is 0.74. Node 6 specifies that among the female physicians below the age of 44, 5 are experiencing TO, 15 are experiencing NTO, and a TO probability is 0.67. Node 7 indicates that between the female physicians above the age of 44, 9 are experiencing TO, 10 are experiencing NTO, and a TO probability is 0.79. In this example, the outcome of the decision tree 550 points towards higher TO among female physicians compared to male physicians.

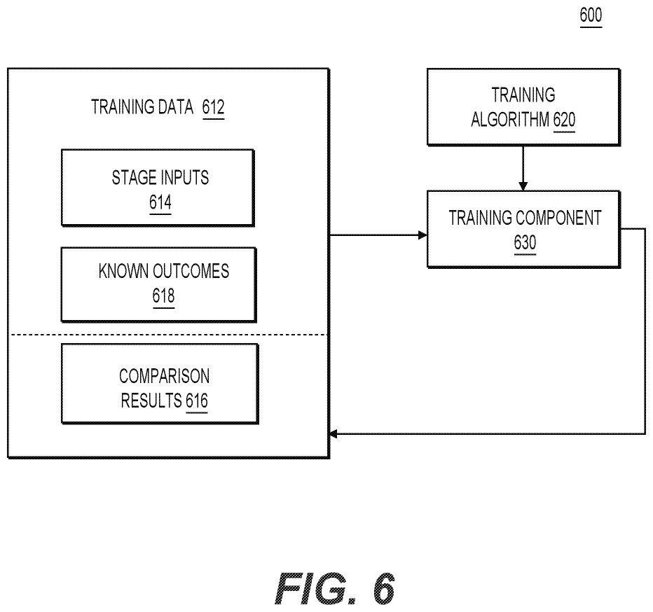

One or more implementations disclosed herein include and/or are implemented using a machine learning model (e.g., the second machine learning model 207, the third machine learning model 221, and the fourth machine learning model 235). For example, one or more of the modules of the analysis platform 111 are implemented using a machine learning model and/or are used to train the machine learning model (e.g., the second machine learning model 207, the third machine learning model 221, and the fourth machine learning model 235). A given machine learning model is trained using the training flow chart 600 of FIG. 6. Training data 612 includes one or more of stage inputs 614 and known outcomes 618 related to the machine learning model to be trained. Stage inputs 614 are from any applicable source including text, visual representations, data, values, comparisons, and stage outputs, e.g., one or more outputs from one or more steps from FIG. 3. The known outcomes 618 are included for the machine learning models generated based on supervised or semi-supervised training. An unsupervised machine learning model is not be trained using known outcomes 618. Known outcomes 618 includes known or desired outputs for future inputs similar to or in the same category as stage inputs 614 that do not have corresponding known outputs.

The training data 612 and a training algorithm 620, e.g., one or more of the modules implemented using the machine learning model and/or are used to train the machine learning model, is provided to a training component 630 that applies the training data 612 to the training algorithm 620 to generate the machine learning model. According to an implementation, the training component 630 is provided comparison results 616 that compare a previous output of the corresponding machine learning model to apply the previous result to re-train the machine learning model. The comparison results 616 are used by training component 630 to update the corresponding machine learning model. The training algorithm 620 utilizes machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine learning model used herein is trained and/or used by adjusting one or more weights and/or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the processes illustrated in FIG. 3 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

FIG. 7 illustrates an implementation of a computer system that executes techniques presented herein. The computer system 700 includes a set of instructions that are executed to cause the computer system 700 to perform any one or more of the methods or computer based functions disclosed herein. The computer system 700 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 700 operates in the capacity of a server or as a client user computer in a server-client user network environment, or as a peer computer system in a peer-to-peer (or distributed) network environment. The computer system 700 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 700 is implemented using electronic devices that provide voice, video, or data communication. Further, while the computer system 700 is illustrated as a single system, the term “system” shall also be taken to include any collection of systems or sub-systems that individually or jointly execute a set, or multiple sets, of instructions to perform one or more computer functions.

As illustrated in FIG. 7, the computer system 700 includes a processor 702, e.g., a central processing unit (CPU), a graphics processing unit (GPU), or both. The processor 702 is a component in a variety of systems. For example, the processor 702 is part of a standard personal computer or a workstation. The processor 702 is one or more processors, digital signal processors, application specific integrated circuits, field programmable gate arrays, servers, networks, digital circuits, analog circuits, combinations thereof, or other now known or later developed devices for analyzing and processing data. The processor 702 implements a software program, such as code generated manually (i.e., programmed).

The computer system 700 includes a memory 704 that communicates via bus 708. Memory 704 is a main memory, a static memory, or a dynamic memory. Memory 704 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 704 includes a cache or random-access memory for the processor 702. In alternative implementations, the memory 704 is separate from the processor 702, such as a cache memory of a processor, the system memory, or other memory. Memory 704 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 704 is operable to store instructions executable by the processor 702. The functions, acts, or tasks illustrated in the figures or described herein are performed by processor 702 executing the instructions stored in memory 704. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 700 further includes a display 710, such as a liquid crystal display (LCD), an organic light emitting diode (OLED), a flat panel display, a solid-state display, a cathode ray tube (CRT), a projector, a printer or other now known or later developed display device for outputting determined information. The display 710 acts as an interface for the user to see the functioning of the processor 702, or specifically as an interface with the software stored in the memory 704 or in the drive unit 706.

Additionally or alternatively, the computer system 700 includes an input/output device 712 configured to allow a user to interact with any of the components of the computer system 700. The input/output device 712 is a number pad, a keyboard, a cursor control device, such as a mouse, a joystick, touch screen display, remote control, or any other device operative to interact with the computer system 700.

The computer system 700 also includes the drive unit 706 implemented as a disk or optical drive. The drive unit 706 includes a computer-readable medium 722 in which one or more sets of instructions 724, e.g. software, is embedded. Further, the sets of instructions 724 embodies one or more of the methods or logic as described herein. Instructions 724 resides completely or partially within memory 704 and/or within processor 702 during execution by the computer system 700. The memory 704 and the processor 702 also include computer-readable media as discussed above.

In some systems, computer-readable medium 722 includes the set of instructions 724 or receives and executes the set of instructions 724 responsive to a propagated signal so that a device connected to network 730 communicates voice, video, audio, images, or any other data over network 730. Further, the sets of instructions 724 are transmitted or received over the network 730 via the communication port or interface 720, and/or using the bus 708. The communication port or interface 720 is a part of the processor 702 or is a separate component. The communication port or interface 720 is created in software or is a physical connection in hardware. The communication port or interface 720 is configured to connect with the network 730, external media, display 710, or any other components in the computer system 700, or combinations thereof. The connection with network 730 is a physical connection, such as a wired Ethernet connection, or is established wirelessly as discussed below. Likewise, the additional connections with other components of the computer system 700 are physical connections or are established wirelessly. Network 730 alternatively be directly connected to the bus 708.

While the computer-readable medium 722 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 722 is non-transitory, and may be tangible.

The computer-readable medium 722 includes a solid-state memory such as a memory card or other package that houses one or more non-volatile read-only memories. The computer-readable medium 722 is a random-access memory or other volatile re-writable memory. Additionally or alternatively, the computer-readable medium 722 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 700 is connected to network 730. Network 730 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. Network 730 includes wide area networks (WAN), such as the Internet, local area networks (LAN), campus area networks, metropolitan area networks, a direct connection such as through a Universal Serial Bus (USB) port, or any other networks that allows for data communication. Network 730 is configured to couple one computing device to another computing device to enable communication of data between the devices. Network 730 is generally enabled to employ any form of machine-readable media for communicating information from one device to another. Network 730 includes communication methods by which information travels between computing devices. Network 730 is divided into sub-networks. The sub-networks allow access to all of the other components connected thereto or the sub-networks restrict access between the components. Network 730 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the present disclosure, various features are sometimes grouped together in a single embodiment, figure, or description thereof for the purpose of streamlining the disclosure and aiding in the understanding of one or more of the various inventive aspects. This method of the present disclosure, however, is not to be interpreted as reflecting an intention that the claimed embodiments require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of the present disclosure.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the present disclosure.

In the description provided herein, numerous specific details are set forth. However, it is understood that embodiments of the present disclosure are practiced without these specific details. In other instances, well-known methods, structures and techniques have not been shown in detail in order not to obscure an understanding of this description.

Thus, while there has been described what are believed to be the preferred embodiments of the present disclosure, those skilled in the art will recognize that other and further modifications are made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

The present disclosure furthermore relates to the following aspects.

Example 1. A computer-implemented method comprising: receiving, by one or more processors, data associated with a first entity from a plurality of data sources, wherein the data includes a control dataset and at least one of a system dataset or a non-system dataset; determining, by the one or more processors via input of a first subset of the control dataset into a first machine learning model, a classification of the first entity; determining, by the one or more processors via input of at least one of the system dataset into a second machine learning model or the non-system dataset into a third machine learning model, at least one of a system score for the first entity or a non-system score for the first entity, respectively, each of the system score and the non-system score representing a likelihood of burnout of the first entity; determining, by the one or more processors via input of at least one of the system score, the non-system score, or a second subset of the control dataset into a fourth machine learning model, a composite score for the first entity, the composite score representing a likelihood of turnover of the first entity; determining, by the one or more processors, at least one of a lateral score or a longitudinal score for the first entity based on at least one of the classification of the first entity or the composite score for the first entity; comparing, by the one or more processors, at least one of the lateral score or the longitudinal score with a pre-determined threshold; and initiating, by the one or more processors, performance of one or more mitigation actions based on the comparison.

Example 2. The computer-implemented method of example 1, wherein determining the classification of the first entity comprises: scaling the first subset of the control dataset associated with the first entity to provide an equal weight to each variable of the first subset of the control dataset; and inputting the scaled first subset of the control dataset into the first machine learning model configured to determine the classification of the first entity, wherein the first machine learning model comprises at least one of a deep embedded clustering algorithm or a K-means clustering algorithm.

Example 3. The computer-implemented method of any of examples 1-2, further comprising training the second machine learning model by: pre-processing a training system dataset to generate a first master training dataset, wherein the pre-processing includes at least one of correlation detection, missing value treatment, outlier treatment, new features creation, scaling, or multivariate analysis; splitting the first master training dataset into a first training dataset and a first validation dataset; and inputting the first training dataset into the second machine learning model to determine a training system score, wherein one or more performance parameters of the second machine learning model are measured using the first validation dataset.

Example 4. The computer-implemented method of any of examples 1-3, further comprising training the third machine learning model by: pre-processing a training non-system dataset to generate a second master training dataset, wherein the pre-processing includes at least one of correlation detection, missing value treatment, outlier treatment, new features creation, scaling, or multivariate analysis; splitting the second master training dataset into a second training dataset and a second validation dataset; and inputting the second training dataset into the third machine learning model to determine a training non-system score, wherein one or more performance parameters of the third machine learning model are measured using the second validation dataset.

Example 5. The computer-implemented method of any of examples 1-4, further comprising training the fourth machine learning model by: pre-processing, by the one or more processors, at least one of a training system score, a training non-system score, or a subset of a training control dataset to generate a third master training dataset, wherein the pre-processing includes at least one of correlation detection, missing value treatment, outlier treatment, new features creation, scaling, or multivariate analysis; splitting, by the one or more processors, the third master training dataset into a third training dataset and a third validation dataset; and inputting, by the one or more processors, the third training dataset into the fourth machine learning model to determine a training composite score, wherein one or more performance parameters of the fourth machine learning model are measured using the third validation dataset.

Example 6. The computer-implemented method of any of examples 1-5, wherein initiating the performance of the one or more mitigation actions comprises: determining, by the one or more processors, the one or more mitigation actions upon determining at least one of the lateral score or the longitudinal score exceeds the pre-determined threshold, wherein the one or more mitigation actions include at least one of intervention by a second entity for managing a workload of the first entity, modifying work schedules of the first entity, delegating activities determined as detrimental to mental health of the first entity, or recommending a time-off or stress-relieving activities.

Example 7. The computer-implemented method of example 6, further comprising: analyzing, by the one or more processors, at least one of the lateral score or the longitudinal score to measure efficacy of the one or more mitigation actions or adherence to the one or more mitigation actions.

Example 8. The computer-implemented method of any of examples 1-7, further comprising: updating, by the one or more processors, at least one of the system score or the non-system score in real-time, near real-time, or on a scheduled basis to dynamically determine the likelihood of burnout of the first entity.

Example 9. The computer-implemented method of any of examples 1-8, wherein the lateral score includes a comparison between one or more scores associated with the first entity and one or more scores associated with other entities within a pre-determined time threshold.

Example 10. The computer-implemented method of any of examples 1-9, wherein the longitudinal score includes a comparison between multiple scores associated with the first entity within a pre-determined time threshold.

Example 11. The computer-implemented method of any of examples 1-10, wherein the control dataset includes at least one of patient panel data, provider registry data, patient complexity data, staffing ratio data, specialty data, patient volume data, patient social determinants of health (SDOH) data, or patient panel race, language, and ethnicity (RLE) data.

Example 12. The computer-implemented method of any of examples 1-11, wherein the system dataset includes at least one of electronic health record (EHR) data, clinical data, national provider identifier (NPI) data, intervention adherence data, net prompter score (NPS) data, historical training data, or task data.

Example 13. The computer-implemented method of any of examples 1-12, wherein the non-system dataset includes at least one of environmental data, social determinants of health (SDOH) data, financial data, health condition data, or activity data.

Example 14. The computer-implemented method of any of examples 1-13, wherein at least one of the first, the second, or the third machine learning model is at least one of Gradient Boosting Machine (GBM), LightGBM (LGBM), or Extra Trees Classifier.

Example 15. A system comprising: one or more processors of a computing system; and at least one non-transitory computer readable medium storing instructions which, when executed by the one or more processors, cause the one or more processors to perform operations comprising: receiving data associated with a first entity from a plurality of data sources, wherein the data includes a control dataset and at least one of a system dataset or a non-system dataset; determining, via input of a first subset of the control dataset into a first machine learning model, a classification of the first entity; determining, via input of at least one of the system dataset into a second machine learning model or the non-system dataset into a third machine learning model, at least one of a system score for the first entity or a non-system score for the first entity, respectively, each of the system score and the non-system score representing a likelihood of burnout of the first entity; determining, via input of at least one of the system score, the non-system score, or a second subset of the control dataset into a fourth machine learning model, a composite score for the first entity, the composite score representing a likelihood of turnover of the first entity; determining at least one of a lateral score or a longitudinal score for the first entity based on at least one of the classification of the first entity or the composite score for the first entity; comparing at least one of the lateral score or the longitudinal score with a pre-determined threshold; and initiating, by the one or more processors, performance of one or more mitigation actions based on the comparison.

Example 16. The system of example 15, wherein determining the classification of the first entity comprises: scaling the first subset of the control dataset associated with the first entity to provide an equal weight to each variable of the first subset of the control dataset; and inputting the scaled first subset of the control dataset into the first machine learning model configured to determine the classification of the first entity, wherein the first machine learning model comprises at least one of a deep embedded clustering algorithm or a K-means clustering algorithm.

Example 17. The system of any of examples 15-16, further comprising training the second machine learning model by: pre-processing a training system dataset to generate a first master training dataset, wherein the pre-processing includes at least one of correlation detection, missing value treatment, outlier treatment, new features creation, scaling, or multivariate analysis; splitting the first master training dataset into a first training dataset and a first validation dataset; and inputting the first training dataset into the second machine learning model to determine a training system score, wherein one or more performance parameters of the second machine learning model are measured using the first validation dataset.

Example 18. The system of any of examples 15-17, further comprising training the third machine learning model by: pre-processing a training non-system dataset to generate a second master training dataset, wherein the pre-processing includes at least one of correlation detection, missing value treatment, outlier treatment, new features creation, scaling, or multivariate analysis; splitting the second master training dataset into a second training dataset and a second validation dataset; and inputting the second training dataset into the third machine learning model to determine a training non-system score, wherein one or more performance parameters of the third machine learning model are measured using the second validation dataset.

Example 19. The system of any of examples 15-18, further comprising training the fourth machine learning model by: pre-processing at least one of a training system score, a training non-system score, or a subset of a training control dataset to generate a third master training dataset, wherein the pre-processing includes at least one of correlation detection, missing value treatment, outlier treatment, new features creation, scaling, or multivariate analysis; splitting the third master training dataset into a third training dataset and a third validation dataset; and inputting the third training dataset into the fourth machine learning model to determine a training composite score, wherein one or more performance parameters of the fourth machine learning model are measured using the third validation dataset.

Example 20. A non-transitory computer readable medium, the non-transitory computer readable medium storing instructions which, when executed by one or more processors of a computing system, cause the one or more processors to perform operations comprising: receiving data associated with a first entity from a plurality of data sources, wherein the data includes a control dataset and at least one of a system dataset or a non-system dataset; determining, via input of a first subset of the control dataset into a first machine learning model, a classification of the first entity; determining, via input of at least one of the system dataset into a second machine learning model or the non-system dataset into a third machine learning model, at least one of a system score for the first entity or a non-system score for the first entity, respectively, each of the system score and the non-system score representing a likelihood of burnout of the first entity; determining, via input of at least one of the system score, the non-system score, or a second subset of the control dataset into a fourth machine learning model, a composite score for the first entity, the composite score representing a likelihood of turnover of the first entity; determining at least one of a lateral score or a longitudinal score for the first entity based on at least one of the classification of the first entity or the composite score for the first entity; comparing at least one of the lateral score or the longitudinal score with a pre-determined threshold; and initiating, by the one or more processors, performance of one or more mitigation actions based on the comparison.

Example 21. The computer-implemented method of any of examples 3-5, wherein the training of one or more of the second, third, or fourth machine learning model is performed by the one or more processors.

Example 22. The computer-implemented method of any of examples 3-5, wherein the one or more processor are in a first computing entity, and wherein the training of one or more of the second, third, or fourth machine learning model is performed by one or more processors of a second computing entity.

What is claimed is:

1. A computer-implemented method comprising:
receiving, by one or more processors, data associated with a first entity from a plurality of data sources, wherein the data includes a control dataset and at least one of a system dataset or a non-system dataset;
determining, by the one or more processors via input of a first subset of the control dataset into a first machine learning model, a classification of the first entity;
determining, by the one or more processors via input of at least one of the system dataset into a second machine learning model or the non-system dataset into a third machine learning model, at least one of a system score for the first entity or a non-system score for the first entity, respectively, each of the system score and the non-system score representing a likelihood of burnout of the first entity;
determining, by the one or more processors via input of at least one of the system score, the non-system score, or a second subset of the control dataset into a fourth machine learning model, a composite score for the first entity, the composite score representing a likelihood of turnover of the first entity;
determining, by the one or more processors, at least one of a lateral score or a longitudinal score for the first entity based on at least one of the classification of the first entity or the composite score for the first entity;
comparing, by the one or more processors, at least one of the lateral score or the longitudinal score with a pre-determined threshold; and
initiating, by the one or more processors, performance of one or more mitigation actions based on the comparison.

2. The computer-implemented method of claim 1, wherein determining the classification of the first entity comprises:
scaling the first subset of the control dataset associated with the first entity to provide an equal weight to each variable of the first subset of the control dataset; and
inputting the scaled first subset of the control dataset into the first machine learning model configured to determine the classification of the first entity,
wherein the first machine learning model comprises at least one of a deep embedded clustering algorithm or a K-means clustering algorithm.

3. The computer-implemented method of claim 1, further comprising training the second machine learning model by:
pre-processing a training system dataset to generate a first master training dataset, wherein the pre-processing includes at least one of correlation detection, missing value treatment, outlier treatment, new features creation, scaling, or multivariate analysis;
splitting the first master training dataset into a first training dataset and a first validation dataset; and
inputting the first training dataset into the second machine learning model to determine a training system score,
wherein one or more performance parameters of the second machine learning model are measured using the first validation dataset.

4. The computer-implemented method of claim 1, further comprising training the third machine learning model by:
pre-processing a training non-system dataset to generate a second master training dataset, wherein the pre-processing includes at least one of correlation detection, missing value treatment, outlier treatment, new features creation, scaling, or multivariate analysis;
splitting the second master training dataset into a second training dataset and a second validation dataset; and
inputting the second training dataset into the third machine learning model to determine a training non-system score,
wherein one or more performance parameters of the third machine learning model are measured using the second validation dataset.

5. The computer-implemented method of claim 1, further comprising training the fourth machine learning model by:
pre-processing at least one of a training system score, a training non-system score, or a subset of a training control dataset to generate a third master training dataset, wherein the pre-processing includes at least one of correlation detection, missing value treatment, outlier treatment, new features creation, scaling, or multivariate analysis;
splitting the third master training dataset into a third training dataset and a third validation dataset; and
inputting the third training dataset into the fourth machine learning model to determine a training composite score,
wherein one or more performance parameters of the fourth machine learning model are measured using the third validation dataset.

6. The computer-implemented method of claim 1, wherein initiating the performance of the one or more mitigation actions comprises:
determining, by the one or more processors, the one or more mitigation actions upon determining at least one of the lateral score or the longitudinal score exceeds the pre-determined threshold, wherein the one or more mitigation actions include at least one of intervention by a second entity for managing a workload of the first entity, modifying work schedules of the first entity, delegating activities determined as detrimental to mental health of the first entity, or recommending a time-off or stress-relieving activities.

7. The computer-implemented method of claim 6, further comprising:
analyzing, by the one or more processors, at least one of the lateral score or the longitudinal score to measure efficacy of the one or more mitigation actions or adherence to the one or more mitigation actions.

8. The computer-implemented method of claim 1, further comprising:
updating, by the one or more processors, at least one of the system score or the non-system score in real-time, near real-time, or on a scheduled basis to dynamically determine the likelihood of burnout of the first entity.

9. The computer-implemented method of claim 1, wherein the lateral score includes a comparison between one or more scores associated with the first entity and one or more scores associated with other entities within a pre-determined time threshold.

10. The computer-implemented method of claim 1, wherein the longitudinal score includes a comparison between multiple scores associated with the first entity within a pre-determined time threshold.

11. The computer-implemented method of claim 1, wherein the control dataset includes at least one of patient panel data, provider registry data, patient complexity data, staffing ratio data, specialty data, patient volume data, patient social determinants of health (SDOH) data, or patient panel race, language, and ethnicity (RLE) data.

12. The computer-implemented method of claim 1, wherein the system dataset includes at least one of electronic health record (EHR) data, clinical data, national provider identifier (NPI) data, intervention adherence data, net prompter score (NPS) data, historical training data, or task data.

13. The computer-implemented method of claim 1, wherein the non-system dataset includes at least one of environmental data, social determinants of health (SDOH) data, financial data, health condition data, or activity data.

14. The computer-implemented method of claim 1, wherein at least one of the first, the second, or the third machine learning model is at least one of Gradient Boosting Machine (GBM), LightGBM (LGBM), or Extra Trees Classifier.

15. A system comprising:
one or more processors of a computing system; and
at least one non-transitory computer readable medium storing instructions which, when executed by the one or more processors, cause the one or more processors to perform operations comprising:
receiving data associated with a first entity from a plurality of data sources, wherein the data includes a control dataset and at least one of a system dataset or a non-system dataset;
determining, via input of a first subset of the control dataset into a first machine learning model, a classification of the first entity;
determining, via input of at least one of the system dataset into a second machine learning model or the non-system dataset into a third machine learning model, at least one of a system score for the first entity or a non-system score for the first entity, respectively, each of the system score and the non-system score representing a likelihood of burnout of the first entity;
determining, via input of at least one of the system score, the non-system score, or a second subset of the control dataset into a fourth machine learning model, a composite score for the first entity, the composite score representing a likelihood of turnover of the first entity;
determining at least one of a lateral score or a longitudinal score for the first entity based on at least one of the classification of the first entity or the composite score for the first entity;
comparing at least one of the lateral score or the longitudinal score with a pre-determined threshold; and
initiating performance of one or more mitigation actions based on the comparison.

16. The system of claim 15, wherein determining the classification of the first entity comprises:
scaling the first subset of the control dataset associated with the first entity to provide an equal weight to each variable of the first subset of the control dataset; and
inputting the scaled first subset of the control dataset into the first machine learning model configured to determine the classification of the first entity,
wherein the first machine learning model comprises at least one of a deep embedded clustering algorithm or a K-means clustering algorithm.

17. The system of claim 15, further comprising training the second machine learning model by:
pre-processing a training system dataset to generate a first master training dataset, wherein the pre-processing includes at least one of correlation detection, missing value treatment, outlier treatment, new features creation, scaling, or multivariate analysis;
splitting the first master training dataset into a first training dataset and a first validation dataset; and
inputting the first training dataset into the second machine learning model to determine a training system score,
wherein one or more performance parameters of the second machine learning model are measured using the first validation dataset.

18. The system of claim 15, further comprising training the third machine learning model by:
pre-processing a training non-system dataset to generate a second master training dataset, wherein the pre-processing includes at least one of correlation detection, missing value treatment, outlier treatment, new features creation, scaling, or multivariate analysis;
splitting the second master training dataset into a second training dataset and a second validation dataset; and
inputting the second training dataset into the third machine learning model to determine a training non-system score,
wherein one or more performance parameters of the third machine learning model are measured using the second validation dataset.

19. The system of claim 15, further comprising training the fourth machine learning model by:
pre-processing at least one of a training system score, a training non-system score, or a subset of a training control dataset to generate a third master training dataset, wherein the pre-processing includes at least one of correlation detection, missing value treatment, outlier treatment, new features creation, scaling, or multivariate analysis;
splitting the third master training dataset into a third training dataset and a third validation dataset; and
inputting the third training dataset into the fourth machine learning model to determine a training composite score,
wherein one or more performance parameters of the fourth machine learning model are measured using the third validation dataset.

20. A non-transitory computer readable medium, the non-transitory computer readable medium storing instructions which, when executed by one or more processors of a computing system, cause the one or more processors to perform operations comprising:
receiving data associated with a first entity from a plurality of data sources, wherein the data includes a control dataset and at least one of a system dataset or a non-system dataset;
determining, via input of a first subset of the control dataset into a first machine learning model, a classification of the first entity;
determining, via input of at least one of the system dataset into a second machine learning model or the non-system dataset into a third machine learning model, at least one of a system score for the first entity or a non-system score for the first entity, respectively, each of the system score and the non-system score representing a likelihood of burnout of the first entity;
determining, via input of at least one of the system score, the non-system score, or a second subset of the control dataset into a fourth machine learning model, a composite score for the first entity, the composite score representing a likelihood of turnover of the first entity;
determining at least one of a lateral score or a longitudinal score for the first entity based on at least one of the classification of the first entity or the composite score for the first entity;
comparing at least one of the lateral score or the longitudinal score with a pre-determined threshold; and
initiating performance of one or more mitigation actions based on the comparison.
